(19) United States
(12) Patent Application Publication
(10) Pub. No.: US 2014/0019753 A1
(43) Pub. Date: Jan. 16, 2014

(54) CLOUD KEY MANAGEMENT

(71) Applicants: John Houston Lowry, Lowell, MA (US); Jonathan A. Rubin, Bedford, MA (US)

(72) Inventors: John Houston Lowry, Lowell, MA (US); Jonathan A. Rubin, Bedford, MA (US)

(21) Appl. No.: 13/545,805

(22) Filed: Jul. 10, 2012

(51) Int. Cl. H04L 9/08

(52) U.S. Cl. 713/155

(57) ABSTRACT

A system for managing encryption keys within a domain includes: a client computer coupled to a cloud key management server over a network, the client computer being configured to supply a request for an encryption key, the request including an object identifier associated with the encryption key; and a cloud key management service comprising the cloud key management server, the cloud key management service being configured to: store a plurality of encryption keys in association with a plurality of object identifiers; receive the request from the client computer; identify an encryption key of the stored encryption keys associated with the object identifier of the request; and send the identified encryption key to the client computer in response to the request.

### BACKGROUND

1. Field

Embodiments of the present invention relate to the field of data security and the management of cryptography keys in an organization.

2. Description of Related Art

Many organizations utilize cryptography to protect sensitive data that should remain confidential or proprietary to that organization. However, current data encryption tools put control (and responsibility) of that sensitive data in the hands of the users of that information. In other words, users store sensitive data in individual files or file systems using keys that the users (and not the organization) control. For example, prior systems utilize software cryptography and encryption keys managed by a public key infrastructure (PKI) (see FIG. 1) that by design and intent are generally bound to and controlled by individuals, not the organization. Referring to FIG. 1, if user A wishes to send an encrypted message to user B in a system where encryption keys are managed by a public key infrastructure, user A may first request the public key PuK_{B} bound to user B. User A may then request a session key (or symmetric key) from a subsystem (e.g., a crypto provider module running locally on user A's machine), use the session key SK to encrypt the cleartext message to produce a ciphertext message. User A may then use the recipient's public key to encrypt the session key SK to produce a “token” or “wrapped key”. The encrypted ciphertext and the token may then be transmitted to user B, who decrypts the token using user B's private key to obtain the session key. User B then uses the decrypted session key to decrypt the ciphertext message to obtain the cleartext message. In such an arrangement, the session keys are controlled by the users (e.g., users A and B) and not by the organization. This means that users are required to understand and utilize all of the tools correctly, all of the time in order to ensure that an organization's sensitive data is and remains protected.

However, these encryption tools are useless if a user maliciously attempts to remove the data from an organization. In addition, users may find the encrypting and decrypting files to be onerous and may thus transport files in unencrypted form for the sake of convenience. Individual training is frequently insufficient to overcome malicious behavior and user carelessness and standard technical means to mitigate these risks are often ineffective or unusable. In cases where the user does correctly remember to encipher data, the organization cannot inspect the contents of the message (e.g., for monitoring and preventing data leaks) because the symmetric key is not controlled by or available to the organization. Finally malware may attempt to move data across organization boundaries or security domains.

Many existing data loss prevention (DLP) techniques are intended to satisfy or exceed statutory and regulatory requirements for data protection, such as Health Insurance Portability and Accountability Act (HIPAA) requirements, Payment Card Industry (PCI) Data Security Standards, and Gramm-Leach-Bliley Act (GLBA) and Sarbanes-Oxley requirements. These solutions are focused on identifying specific types of content in storage or in transit and controlling its dissemination. Some vendors like Zscaler® offer cloud compute services as a platform for inspection engines that address Web and Email. There are a large number of vendors that provide “data loss prevention” services and technologies. However, while these vendors generally have the feature of taking control of information protection from the user, they generally only address and detect the transmission of limited types of data and information such as social security numbers, credit card numbers, and specified words and phrases (e.g., using pattern matching algorithms).

In addition, proxy services are focused on access control and malware detection. Some of these services (such as Blue Coat®) provide a cloud service model in addition to hardware and software solutions. However, none of these services control data movement across organization boundaries, e.g., by inspecting the data and performing filtering of the data. In addition, when a user is granted access to use a proxy, that access is enabled for long durations and generally may be used for any kind of data. Proxy services generally do not perform inspection of the data and, as such, the organization generally is not able to detect what data is flowing in and out through the proxy service.

The Kerberos computer network authentication protocol is commonly used to allow nodes in a network to authenticate with one another (e.g., for a user on a network to authenticate or “sign-in” to a file server to access the files stored on the server). As such, the Kerberos system generally focuses on protecting communications sessions between nodes of interest within a pre-defined domain and not on protecting objects (e.g., documents, emails, storage volumes, etc.).

### SUMMARY

Embodiments of the present invention are directed to a system and method for providing encryption key management services in an organization or an Internet cloud for devices and individuals, thereby giving the organization control over their information instead of relying on organization members to maintain the secrecy of the encryption keys. The choice of whether, when, and to what device or person keys get distributed is a building block for an organization to define finely specified and robust data protection boundaries that provide significantly more power and flexibility than systems available today.

Cloud key management (CKM) services provide a security service from a computing cloud to devices registered to that service and during transfers of data between cooperating computing clouds. CKM addresses the problem of maintaining control of data within an organization. It deals directly with careless users, some types of malicious users (insider threats), and provides some defense against the ability of malware to steal sensitive data. It replaces reliance on individual user training and poor key management facilities on commodity machines with a cloud-based policy and key management service. The service supports multiple interior (local) security domains and enforces policy by providing keys (or not) to devices and systems that invisibly encrypt data. The environment serviced by an instance of the CKM services and the policy (or policies) it enforces defines a security domain and its use captures information about successful or rejected transfers of data across domain boundaries.

According to some embodiments of the present invention, a set of cryptographic services can be deployed in an organizationally controlled cloud along with a set of client-side cryptography applications that will run on client computers, which includes user workstations (or “machines”) and other authorized computing devices (e.g., smartphones, tablets, personal digital assistants, etc.) capable of using key material and capable of participating, directly or indirectly, with the cryptographic services deployed in the cloud. These cryptographic services, or “cloud key management” (CKM) service, include key management, key distribution, and archiving of metadata (and possibly hashes or complete documents because data storage is relatively inexpensive). The CKM service is controlled by the organization. User workstations and devices that use symmetric keys within the domain, not users, register for access to the CKM service (restricted to the access provided through the service protocols). In other words, the selection and use of encryption keys is determined, not by end-users, but by organizationally-set rules which are stored within and processed by the client-side cryptography applications.

The client-side cryptography applications according to some embodiments of the present invention will be configured to run “behind the scenes,” such that the user does not even know that they are there. For example, within a Microsoft® Windows® environment, the client-side cryptography application may be implemented as a Cryptographic Service Provider (CSP) and may be accessed through standard APIs, here, the Microsoft CryptoAPI (CAPI). However, the client-side cryptography applications will provide the capability of negotiating with the CKM service to keep all data encrypted when the data moves (e.g., except when the data is being actively used on the user workstation or when the data is stored in an otherwise secured and/or stationary medium). In addition, storing audit data related to key requests, key issuances, clients, key transfers, key revocations, and other aspects of key management provides organizations with the opportunity to understand data movements, predict and identify risks, and to conduct forensics.

Embodiments of the present invention may employ existing tools and techniques in shared-secret and public-key cryptography to ensure that all data is encrypted whenever it crosses a boundary. An organization may define one or more data boundaries that constitute the organization's data domain. The data boundary can be bound to the device (e.g., workstation), application (e.g., email), and user (e.g., by login name) in any combination relevant to the policy the organization wishes to enforce. Within the organization's computer systems, sensitive data that crosses the domain boundary or has the potential to cross a domain boundary is encrypted using keys issued and managed by the CKM service. When data is reintroduced into a domain or is delivered to a cooperating and authorized domain, authorized users in the domain can decrypt it without intervention. In particular, the encryption keys and the security policy that decides when and how data are encrypted and decrypted are under the control of the organization, and not the individual user.

In more detail, according to embodiments of the present invention, all data objects in motion (e.g., across boundaries of the domain) are encrypted and decrypted by the organization using cloud-based services (e.g., a CKM server) for key management, and auditing. Boundaries of the domain include, for example, file I/O, network I/O, USB, CD/DVD, etc. Objects (e.g., files, emails, data streams being transferred over a network, and data on removable and fixed media) are protected using encryption keys supplied by the organization, not by keys associated with a user.

Data within the organization can be decrypted within the organization-specified boundary or domain. Data crossing over to another organization or party is encrypted for that entity. Audit records and optional reference copies of data may also be stored in the cloud by the CKM service, as configured by the organization, for retention and analysis. These audit records support pattern analysis for insider threat detection and forensics. Boundary inspection of objects can be done to ensure appropriate transforms were performed.

Applications that support encipherment remain supported within the system because the cloud key management of data is substantially transparent to client software and would be similar to other real-time network transactions, such as the domain name service (DNS) or the world wide web, in which end users do not need to be familiar with the details of how the underlying technology operates.

According to one embodiment of the present invention, a system for managing encryption keys within a domain includes: a client computer coupled to a cloud key management server over a network, the client computer being configured to supply a request for an encryption key, the request including an object identifier associated with the encryption key; and a cloud key management service comprising the cloud key management server, the cloud key management service being configured to: store a plurality of encryption keys in association with a plurality of object identifiers; receive the request from the client computer; identify an encryption key of the stored encryption keys associated with the object identifier of the request; and send the identified encryption key to the client computer in response to the request.

The object identifier may be associated with an encrypted file, an encrypted email, encrypted network traffic, an encrypted removable medium, or an encrypted fixed medium.

The cloud key management server may be further configured to determine whether the client is authorized to access the requested encryption key.

The cloud key management server may be further configured to deny access to the requested encryption key if the client is not within the domain.

The request may further include user credentials and the cloud key management server may be further configured to deny access to the requested encryption key if the user credentials are not authorized to access the requested encryption key.

The request may further include information regarding device identity, device credentials, device capabilities, and physical location of the device.

The cloud key management server may be further configured to receive the request via another cloud key management server within another domain, the client being coupled to the another domain.

The cloud key management server may be further configured to store a log, the log including: a timestamp associated with the request; the object identifier; and a client identifier associated with the client computer.

The log may further include a user credential associated with the request.

The user credential may be a username.

The log may further include metadata related to the object identifier, the metadata including at least one element selected from the group consisting of a file type, a file size, a description, a source, an access control list, and any other contextual information that is available or can be derived about the request.

The cloud key management service may be further configured to generate the encryption key.

According to another embodiment of the present invention, a method of managing and supplying encryption keys within a domain includes: storing a plurality of encryption keys in association with a plurality of object identifiers; receiving a request from a client computer for an encryption key, the request including an object identifier; identifying an encryption key of the stored encryption keys associated with the object identifier of the request; and sending the encryption key associated with the object identifier to the client computer in response to the request.

The object identifier may be associated with an encrypted file, an encrypted email, encrypted network traffic, an encrypted removable medium, or an encrypted fixed medium.

The method may further include determining whether the client is authorized to access the requested encryption key.

The method may further include denying access to the requested encryption key if the client computer is not within the domain.

The request may further include user credentials, and the method may further include denying access to the requested encryption key if the user credentials are not authorized to access the requested encryption key.

The method may further include receiving the request via a cloud key management server connected to another domain, the client computer being coupled to the another domain.

The method may further include storing a log, the log including: a timestamp associated with the request; the object identifier; and a client identifier associated with the client computer.

The log may further include a user credential associated with the request.

The user credential may be a username.

The method may further include generating the encryption key.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a figure illustrating the secure transmission of a message using a public key infrastructure system.

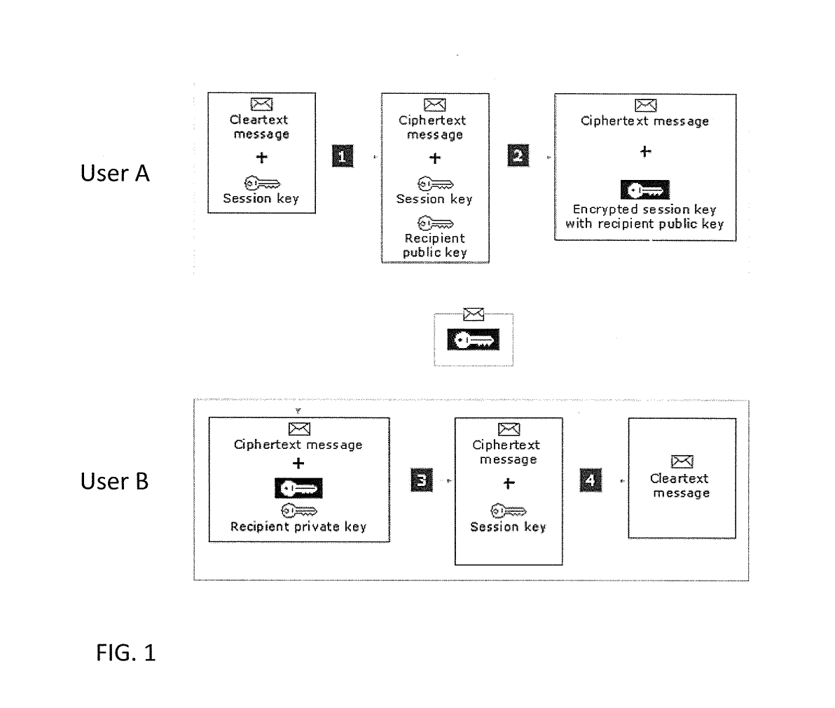

FIG. 2A is a diagram illustrating a cloud key management (CKM) service operating within a domain and connected to user workstations over a network according to one embodiment of the present invention in which a user workstation encrypts a document using a key retrieved from the CKM service according to one embodiment of the present invention.

FIG. 2B is a flowchart illustrating a method of detecting a user request to transfer data across a boundary of a data domain of the organization and encrypting the data prior to transferring the data across the boundary according to one embodiment of the present invention.

FIG. 2C is a flowchart illustrating one method of processing requests for encryption keys in a CKM service according to one embodiment of the present invention.

FIG. 2D is a diagram illustrating a CKM service operating within a domain in which a user workstation decrypts a document using a key retrieved from the CKM service according to one embodiment of the present invention.

FIG. 3A is a diagram illustrating a process by which a user workstation requests, receives, and decrypts a file stored on a networked file server and encrypts and stores the file on a removable medium according to one embodiment of the present invention.

FIG. 3B is a flowchart illustrating a process by which a CKM service receives and processes requests to generate a key for a requestor.

FIG. 4A is a diagram illustrating a cloud key management system having multiple domains according to one embodiment of the present invention.

FIG. 4B is a flowchart illustrating a method according to one embodiment of the present invention by which a CKM service requests an encryption key from a CKM service of a different domain.

FIG. 4C is a flowchart illustrating a method by which a first CKM service processes requests from another CKM service according to one embodiment of the present invention.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

Organizations often protect sensitive data by encrypting the data. However, the encryption and decryption keys used with the data are typically bound to and controlled by individual users within the organization rather than being controlled by the organization itself. As such, even with training, malicious or careless users who do not adhere to organizational policies regarding the handling of sensitive data may cause that sensitive data to be leaked outside the organization because the individual remains in control of the keys. Malware also poses a threat of exfiltration that can be substantially contained or defeated with cryptographic boundaries and policy-driven management provided by CKM.

Embodiments of the present invention are directed to a cloud key management (CKM) service which manages encryption and decryption keys such that the organization retains control of the keys and users are not made responsible for directly generating, using, and for safeguarding these keys. This shifts focus for protecting organizational data from individual training and local detection and monitoring mechanisms to centrally controlled and configured encryption, policy definition and auditing mechanisms. As such, a CKM service according to one embodiment of the present invention allows an organization to exert direct positive control of their data—protecting data from unauthorized release and exfiltration (e.g., the unauthorized release of data from within a computer system) using cryptography in combination with cloud key management, protocols, and audit storage. These cloud-based cryptographic and key management services can be implemented using existing standards and emerging capabilities.

CKM systems according to embodiments of the present invention can be used to make data encryption substantially transparent or invisible to users while they are using workstations within an organization's domain (e.g., using computers controlled by the organization and securely connected to the organization's computer network). CKM systems can also keep detailed logs of when and under what circumstances all files encrypted by the CKM system are accessed, because an encryption (or decryption) key is requested from the CKM system every time an encrypted file is read or written to. As such, the detailed access logs are available for performing forensic investigations, detecting suspicious behavior or other threats, monitoring system usage, and other analysis.

In addition, in some embodiments of the present invention, the full hard drives (or solid state drives, drive partitions, and file systems) of the user workstations are encrypted using a key stored by the CKM service. As such, these workstations are unbootable and unusable using their internal drives unless they are operated within the domain of the organization.

CKM services associated with one organization according to embodiments of the present invention may also cooperate with CKM services associated with another organization to participate in key exchange such that files under the control of one organization can be accessed from another domain outside the organization or so that portable user workstations (e.g., laptop computers) secured by the CKM services of one organization may be used while visiting another organization.

Examples of communication channels that can be protected by CKM include email (e.g., where the domain is defined by email address), network (e.g., where the domain is defined by network address), removable media, or connection endpoint address. For example, if a bad actor attempted to extract and publicly disseminate information from a classified network protected by CKM, he could have been allowed to download thousands of classified documents (e.g., state department cables) and burn them to a CD, but the documents would have been automatically and invisibly encrypted with a key unknown to the bad actor and therefore would have been unreadable once he removed the CD from the domain (e.g., the contents of the CD would not be readable by computers outside the domain because those computers would not have had access to the encryption key). Further, all of this activity would be logged and available for analysis and alerting.

Embodiments of the present invention can also add significant new capabilities to existing government and corporate security systems. The technology, when incorporated into these infrastructures, provides organizations with the ability to manage the process of issuing and revoking cryptographic keys, analyze and report usage patterns for those keys (metadata analysis), create multiple cryptographically-enforced boundaries or containers for information within the organization, and remove responsibility for information boundary enforcement from individual members within the organization. Embodiments of the present invention could provide a management overlay to or be added to systems for monitoring information technology systems (e.g., Raytheon's® SureView® program, which is currently being used by the Defense Information Systems Agency (DISA) of the United States Department of Defense (DoD) to provide security for warfighters' computers in the field). It would be an attractive offering since it would have blocked exfiltration of data used in the 2010 WikiLeaks publication of classified data while permitting controlled dissemination of information based on the organization's policies. Embodiments of the present invention could be used in large corporations that need to control proprietary or sensitive financial information, law enforcement and other investigative organizations attempting to keep information related to developing cases private, and medical institutions who have to comply with the Health Insurance Portability and Accountability Act (HIPAA) regulations.

More specifically, cloud key management (CKM) services according to embodiments of the present invention provide key generation, dissemination, revocation, archive, and metadata storage and analysis for organizations. CKM services allow organizations to provide cryptographic key management services to devices and services deployed within an organization or between organizations. The CKM services provide the key management infrastructure that allows an organization to establish cryptographically enforced separation (or protection) domains that serve as invisible containers. The combined approach of CKM and cryptographic processing technologies mitigates or prevents accidental or malicious insider threats, provides significant data leak prevention (DLP), and provides a controlled means to share information across separation domains and organizations based on organization policy.

According to embodiments of the present invention using the CKM model, the organization cloud provides the encryption key as part of services provided by the organization. The organization keeps a copy of they key and other meta data about its own actions and any that is supplied by the user's device. Client side encryption software (e.g., connected to the user's email program) encrypts the symmetric key using the public key of the recipient and possibly the user's public key. The resulting objects (a symmetric key encrypted in a Public key) are called tokens or wrapped keys in the literature. The encrypted message and the tokens are bundled and then sent to the recipient. On the way out of the domain (or “enclave”), the message passes through the organization's email server which may be augmented with content inspection systems which are used to meet organizational requirements for data leak prevention.

If the message is encrypted using a symmetric key that only the end-user knows, then the inspection system is defeated because it cannot view (decrypt) the data. However, in embodiments of the present invention using the CKM model, the organization can grant permission to the inspection system to use the CKM service to retrieve the symmetric key protecting that message. The inspection system can then decrypt the message and inspect its contents.

To handle incoming messages, cooperating organizations could link their respective CKM services using trusted mechanisms and the organization receiving an encrypted message could request the sending organization to provide a copy of the key used on the incoming message. This would enable the receiving organization to inspect the content and make an acceptability determination.

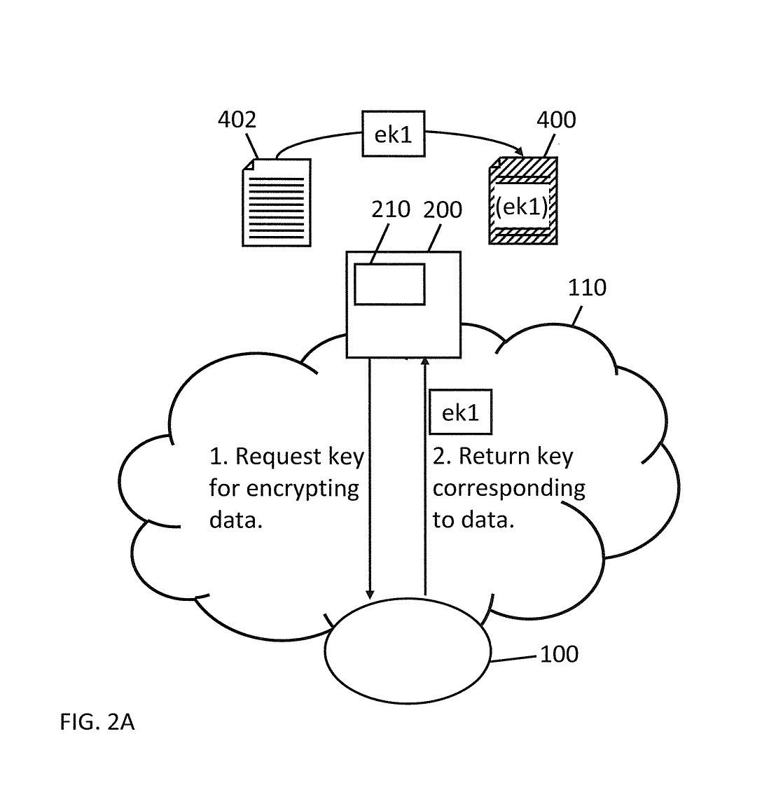

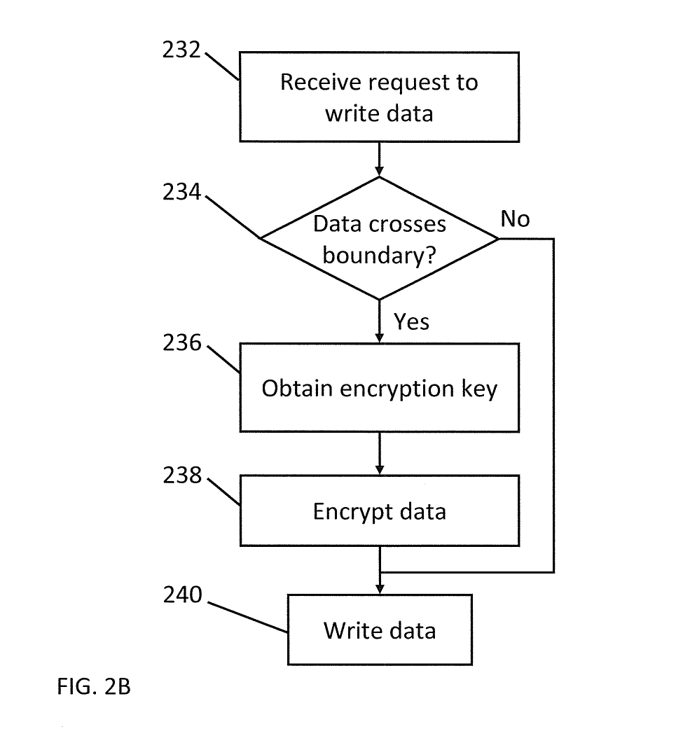

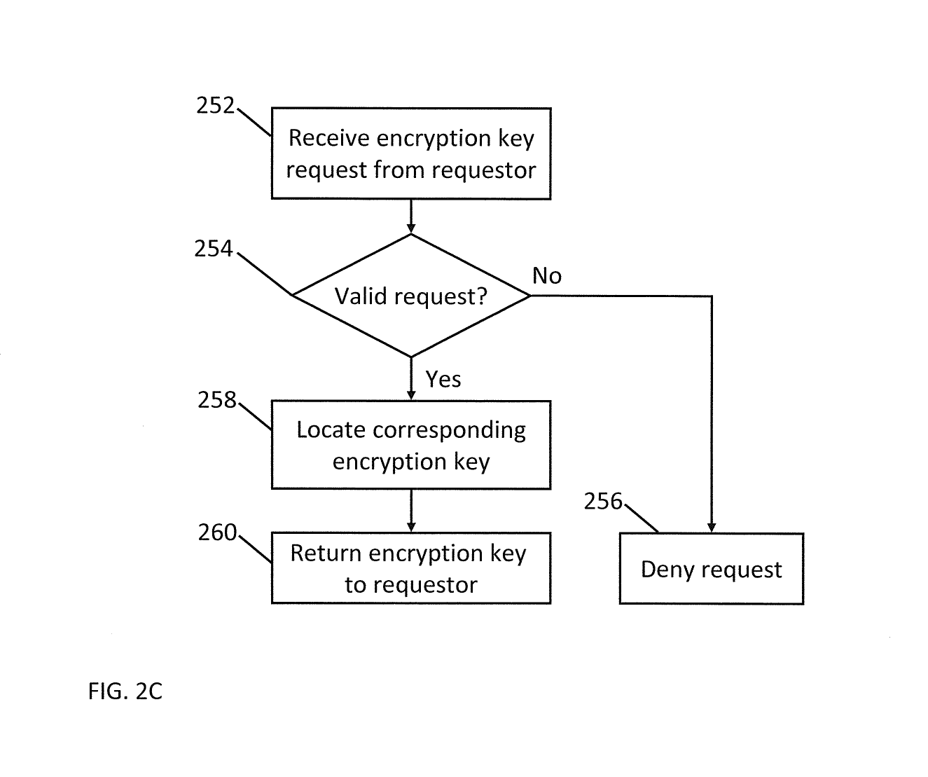

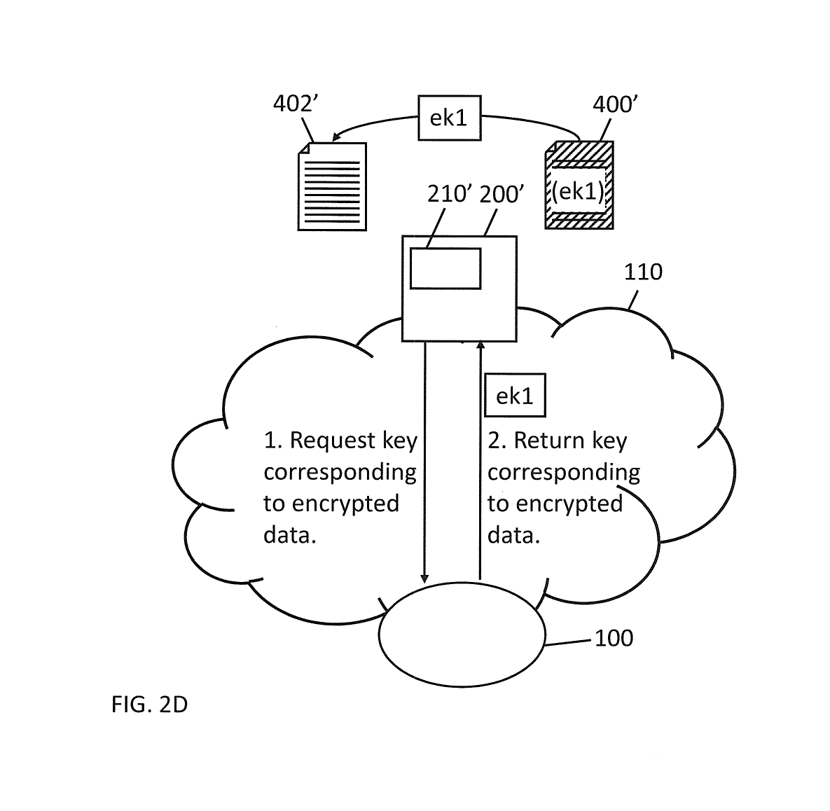

FIG. 2A is a diagram illustrating a cloud key management (CKM) service 100 operating within a domain and connected to user workstations 200 over a network 110 according to one embodiment of the present invention. A cloud key management (CKM) service (or server) 100 is coupled to one or more user workstations (or clients) 200 over a network 110 (or cloud). The communications conducted between user workstations 200 and the CKM service 100 over the network can be encrypted according to known techniques such as the Transport Layer Security (TLS) family of protocols.

As shown in the embodiment of FIG. 2A, the user workstation 200 includes a client-side cryptography application 210. The client-side cryptography application 210 may be implemented using hardware, software, firmware, or combinations thereof. The client-side cryptography application is configured to manage the encryption and decryption of data on the user workstation 200 by requesting keys from a CKM service 100 over a network and by encrypting or decrypting data using the requested keys. According to one embodiment, the client-side cryptography application 210 operates substantially transparently to the user such that little to no user intervention is required for it to operate.

Still referring to FIG. 2A, a client-side cryptography application 210 may detect a user request or action to transfer unencrypted data 402 stored on the user workstation 200 across a boundary of a data domain of the organization. For the sake of convenience, the word “file” is used herein to refer to any data 402 protected by embodiments of the present invention, where the data may be in the form of, for example, a data file, an email, a network connection (e.g., a network session over wired or wireless physical layers), an entire volume of a disk drive, an entire volume of a removable flash drive, other data streams, etc. Such a request or action includes, but is not limited to, sending an email to an address outside of the organization, opening a network connection to an IP address outside of the organization, saving a file to a removable or fixed drive, and saving a file to removable flash memory (e.g., a USB flash drive). If the user request would cause the data to cross a boundary, the client-side cryptography application 210 requests an encryption key “ek1” for encrypting the data 402 to generate encrypted data 400 prior to transferring the data across the boundary.

FIG. 2B is a flowchart illustrating a method detecting a user request to transfer data across a boundary of a data domain of the organization and encrypting the data prior to transferring the data across the boundary according to one embodiment of the present invention. Initially, the client-side cryptography application 210 may receive (or detect) a user request to write data 232 (or perform an operation that might cause data to cross a boundary). The client-side cryptography application 210 then determines 234 whether the request would cause data to cross a boundary, based on a set of rules (e.g., writing a file to a removable drive). If not, then the request is processed 240 without encrypting the data. If the conditions for encrypting the data are satisfied, then the client-side cryptography application requests and obtains 236 an encryption key (e.g., a symmetric encryption key) from a CKM service 100. The client-side cryptography application then encrypts 238 the data using the received encryption key and processes 240 the request using the encrypted data (e.g., by writing the encrypted data to the removable drive).

FIG. 2C is a flowchart illustrating one method of processing requests for encryption keys in a CKM service according to one embodiment of the present invention, the CKM service 100 receives an encryption key request from a requestor (e.g., from a client-side cryptography application 210 running on a user workstation 200) 252. The CKM service 100 then determines whether request is valid 254 by determining, for example, whether the requestor is connected to the proper network (e.g., based on IP address), whether the supplied user or user workstation is authorized to access the requested encryption key (and hence the corresponding data) based on the user or workstation authentication tokens, the username and password supplied, the cryptographic signature, or any other authentication techniques known in the art. If the CKM service 100 determines that the received request is not valid, then the request for the encryption key is denied 256. On the other hand, if the request is valid, then the CKM service 100 locates the corresponding encryption key (e.g., stored in a database or key-value store) and returns the encryption key to the requestor 260. In some embodiments of the present invention, the encryption key (e.g., “ek1”) is encrypted and securely transmitted to the requestor via any of a number of known secure transfer protocols such as Transport Layer Security (TLS).

FIG. 2D is a diagram illustrating an embodiment substantially similar to FIG. 2A in which a user at workstation 200′ would like access to encrypted data 400′ (e.g., a file, an email, an entire disk, a disk partition, a removable volume, etc.) stored locally on the user workstation 200′, the client-side cryptography application 210′ sends a request to the CKM service 100 for the encryption key associated with the encrypted data 400′. For example, as shown in FIG. 2D, the data is encrypted using a first encryption key “ek1′”. The encrypted data 400′ may include metadata which encodes a substantially unique identifier associated with the encrypted data.

Still referring to FIG. 2D, the request sent by the client-side cryptography application 210′ includes the identifier associated with the encrypted data and may also include authentication information such as a username, a password, a user authentication token, user workstation identification information (e.g., current IP address, MAC address, cryptographic signature, machine authentication token). If the proper authentication information was provided in the request, the client-side cryptography application 210′ receives an encryption key (e.g., key “ek1”) from the CKM service 100. The client-side cryptography application 210′ then uses the received encryption key ek1 to decrypt the encrypted data 400′, thereby allowing the user to view decrypted data 402′.

In some embodiments of the present invention, data items (e.g., documents and emails) or devices (e.g., laptops, smartphones, tablets, etc.) can be tagged with organizational access control information (e.g., security classification level, or a list of whitelisted or blacklisted users) and access could be granted or denied based on the credentials supplied by the user requesting the decryption key (e.g., based on whether the user has authority to access the information).

CKM can be integrated with full-disk, partition, or file system encryption tools by managing the key used to decrypt the disk. In embodiments of the present invention where the boot disk (or boot volume or boot partition) of the user workstation 200 is encrypted, the client-side cryptography application 210 requests the encryption key during the boot process in order to decrypt the operating system software on the boot disk. During the boot process, the client-side cryptography application may also prompt the user for authentication information (e.g., a username, password, and token) obtain the encryption key for the boot disk from the CKM service 100.

Machines that leave the domain (perhaps defined as disconnecting from the network) would be unable to decrypt the disk information while outside the domain. This protects laptops that are “sleeping” in transit. When awakened under conditions in which the machine is once again within the domain, a key management module (e.g., software or hardware in the machine) would seek and obtain a key from the cloud and processing or use of the machine could then resume. The policy can be amended and extended to support authorized use outside the domain and for backup purposes.

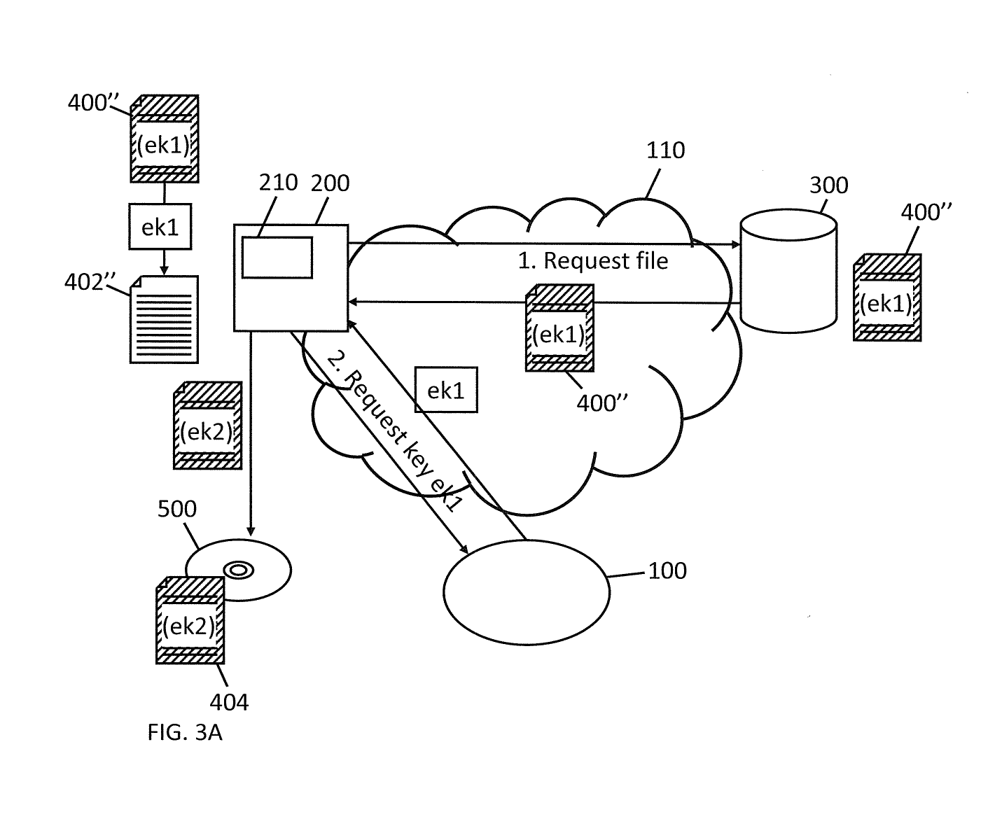

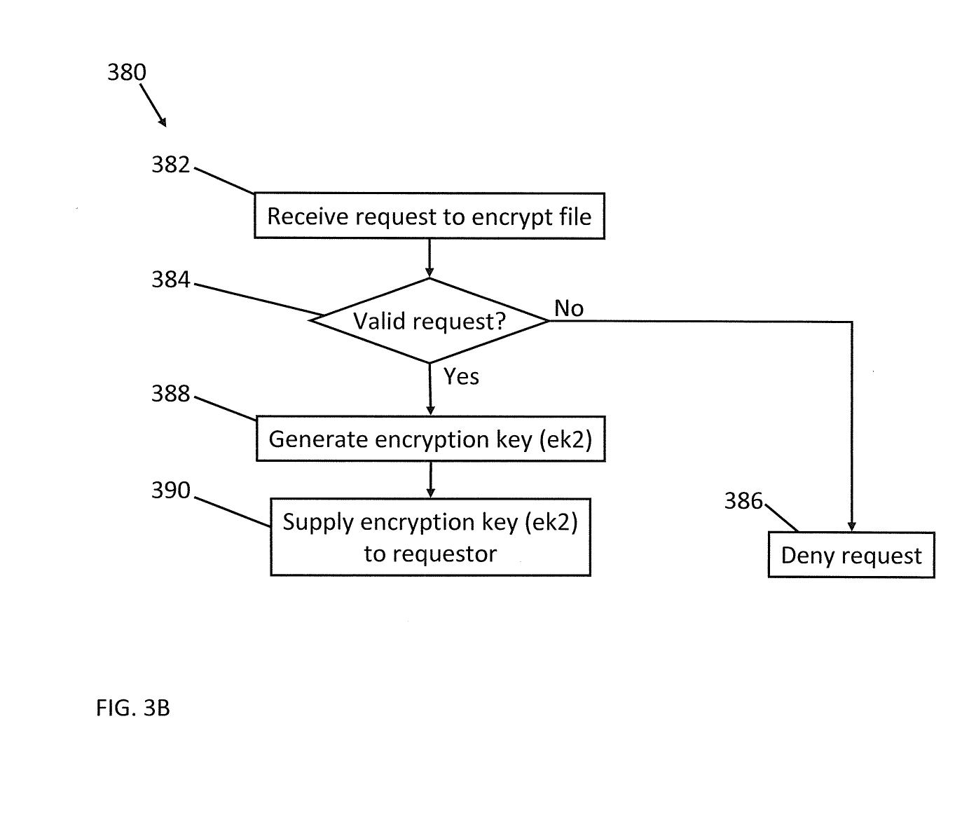

FIG. 3A is a diagram illustrating a process by which a user workstation 200 requests, receives, and decrypts a file 400″ stored on a networked file server 300 according to one embodiment of the present invention. Referring to FIG. 3A, a user on a user workstation 200″ attempts to access a file 400″ stored on a file sever 300. The file 400″ is stored on the file server 300 in encrypted form, encrypted by a first encryption key ek1 (e.g., in FIG. 3A, the diagonal hashing and the label on file 400″ are used to indicate that the file 400″ is encrypted by encryption key ek1). The encrypted file 400″ is transmitted over the network 110 to the user workstation 200.

When the user workstation 200″ receives the encrypted file 400″, the client-side cryptography application 210″ detects the encryption on the file 400″ and requests a decryption key from the CKM service 100 over the network 110 in a manner substantially similar to the method described above with respect to decrypting files stored locally on the user workstation 200. E.g., the user workstation 200 may request the decryption key associated with the file 400″ from the CKM system and then decrypt the received encrypted file 400″ using the received decryption key ek1.

FIG. 3A also depicts a process by which a user workstation 200 stores the decrypted file 402″, re-encrypted as encrypted file 404, on a removable medium 500 (e.g., a CD-ROM, a USB flash drive, an external hard drive, etc.) according to one embodiment of the present invention. Prior to writing the file onto the removable medium 500, the client-side cryptography application (or CKM client, CKMC) 210 may detect that the writing of the file 402″ onto the removable medium 500 would satisfy the conditions for crossing a boundary of the organizational domain and that the file should therefore be encrypted before it is written. As such, the CKM client 210 requests an encryption key from the CKM service 100 in a manner substantially similar to that described above with respect to FIGS. 2A and 2B. The CKM service (or CKM server CKMS) 100 provides a second encryption key ek2 to the client-side cryptography application 210 (or, in some embodiments, the same encryption key ek1 used to encrypt file 400″), which uses the received encryption key to encrypt the decrypted file 402. The encrypted file 404 is then written to the removable medium 500.

When providing the second encryption key ek2, according to some embodiments of the present invention, the CKM service 100 also stores a copy of the encryption key ek2 in association with an identifier associated with the file 404.

FIG. 3B is a flowchart illustrating a method 380 by which a CKM service 100 provides and stores the encryption key ek2 for storing the file 400 on the removable medium 500, according to one embodiment of the present invention. The CKM service 100 receives a request to encrypt a file 400 from a requestor (e.g., a user workstation 200 running a client-side cryptography application 210) 390. As described above, the request may include information such as authentication credentials and an identifier (e.g., a variety of metadata associated with satisfying the key request) associated with the file to be encrypted. The CKM service 100 validates the request 384. If the request is not valid, then the CKM service 100 denies the request 386. If the request is valid, then the CKM service 100 generates an encryption key (e.g., ek2) 388 and supplies the generated encryption key (ek2) to the requestor 390. The generated encryption key ek2 and the identifier associated with the file, as provided in the request, are stored together by the CKM service 100 (e.g., in a database of the CKM service 100). In some embodiments of the present invention, instead of generating a new encryption key, the CKM service 100 locates a previously generated and stored encryption key in accordance with the identifier supplied in the request.

As can be seen in FIG. 3A, the client-side cryptography application 210 communicates with the cloud-based CKM server (CKMS) 100 whenever it decrypts or moves a file. According to one embodiment of the present invention, the CKMS 100 produces metadata or records (e.g., an audit log) every time a file is encrypted or decrypted (which corresponds to the file being viewed or moved), where the log may include the time of request (timestamps), devices used, users (e.g., usernames) served, hosts, data names and types, file information, and destinations or client machines (e.g., IP addresses, MAC addresses, etc.) or any other context that is supplied or can be derived. This audit log provides a source of data for analysis that may be used to track the behavior of individuals and the movement of data within the domain. This metadata may assist in performing forensic and counter-intelligence investigations, and may also be useful in evaluating risks, identifying threats, and performing resource planning (e.g., measuring computer and data usage throughout the organization). For example, the audit log data may be used to identify suspicious data access by a user and to track the movement of individual files across the network in near real-time.

As discussed above, the overall technical approach of CKM systems according to embodiments of the present invention is to provide key management to encrypt documents while the documents are in transit and in storage (or otherwise not actively being used), with keys that are not selected by the user and that are not maintained on the user machine 200. In some embodiments, organizational policies could be relaxed such that documents are only encrypted when leaving the domain.

Because the encryption keys according to embodiments of the present invention are stored primarily in the CKM cloud (and only temporarily stored on the user machines 200) and the protected objects (e.g., files, emails, network traffic, removable disks, etc.) are stored separately from the encryption keys (e.g., on the user machine 200, on a removable medium 500, or on a shared file server 300), an association between a protected object and its encryption key must be maintained so that the CKM system can always “find” the correct key for a document.

In one embodiment of the present invention, in the case of compound document formats such as MIME, MHTML, and XML (Microsoft Word), a signed unique ID may be added to a metadata field embedded in the document to be used as an identifier identifying the protected object. For a plain text document, other tools may be used to store the identifier (e.g., storing the identifier in file system metadata as supported in, e.g., Microsoft® NTFS).

CKM systems according to embodiments of the present invention effectively provide organizations with the capability to define domain boundaries, and to control when and how data is allowed to cross those boundaries (i.e., how the data is allowed to leave the organization). This control is achieved not by restricting what data a user can have access to (although existing access control mechanisms remain supported), nor by what writeable media the user is allowed to use (e.g., CD-R, USB drives, etc.), but by ensuring that data crossing a domain boundary is always encrypted with a key (unknown to the user) that ensures that the data cannot be “read” outside the domain.

In environments without a CKM system, preventing a user from “walking off” with sensitive organization data generally requires restricting the user's access to (and authority to use) external network access and/or removable media. On the other hand, with a CKM service 100 according to embodiments of the present invention, users can download documents freely and burn DVDs or copy the documents on to removable media at will, but these actions will only produce encrypted media that are useless outside of the organization or domains defined by the organization because computers outside of the organization or domain will not have access to the encryption keys stored in the CKM service 100.

In other words, aspects of embodiments of the present invention are directed to trying to protect data that is crossing domain boundaries (i.e., leaving the user machine). For example, if a user has a document open for editing, the existing operating system security mechanisms (e.g., process memory isolation, etc.) protect that data from malicious software. However, even if a piece of malware or a malicious user manages to copy the data into another location in memory, once the data is written to disk it will again become encrypted by the CKM client-side cryptography application 210.

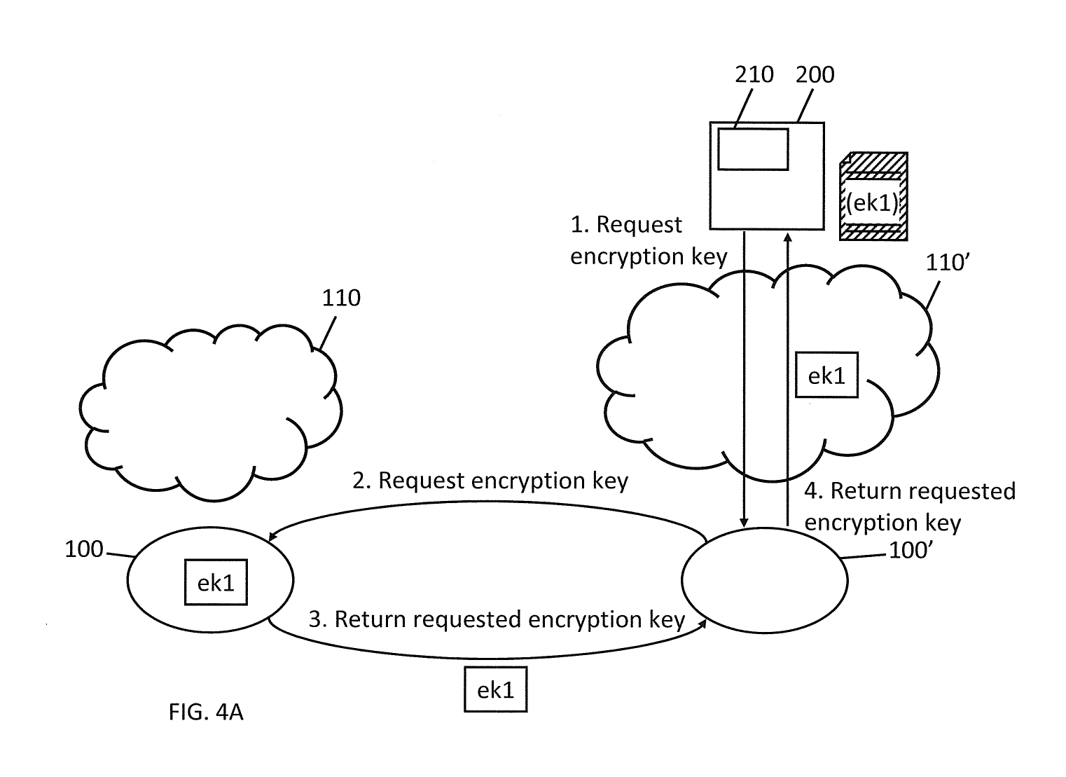

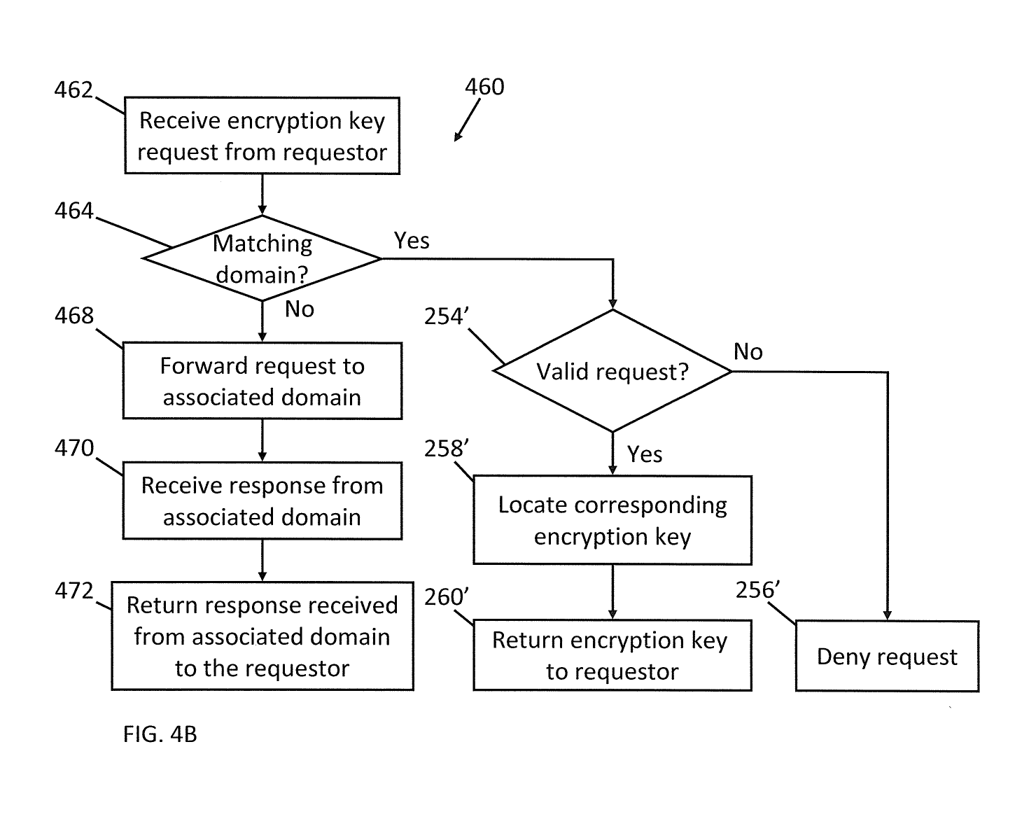

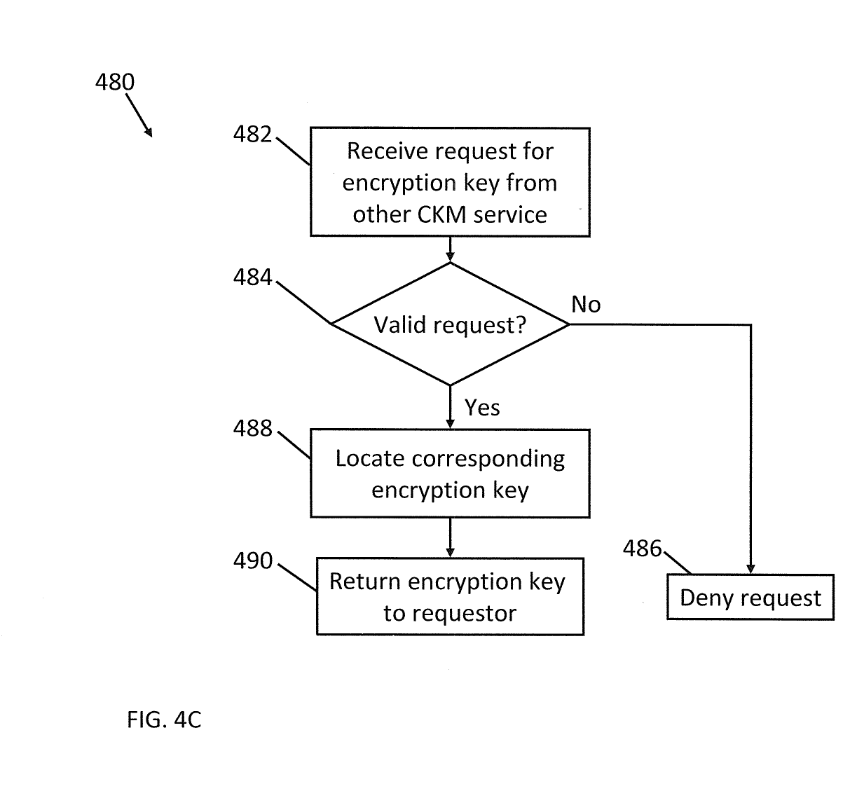

As illustrated, for example, in FIGS. 4A, 4B, and 4C, according to one embodiment, organization domains can use standard or government public key infrastructure (PKI) techniques to share keys between clouds, thereby allowing access to encrypted data from other domains. Protection policies would be jointly agreed upon between the organizations and the sites and would allow the transport of information from one domain to another while protecting information in transit. An employee with a laptop could travel from one domain to another and seamlessly resume processing if the two domains (or clouds) agreed to exchange key material and to implement compatible CKM services.

FIG. 4A is a diagram illustrating a cloud key management system having multiple domains according to one embodiment of the present invention. According to one embodiment of the present invention, a user machine 200 (e.g., running a client-side cryptography application 210) may request an encryption key (e.g., ek1) stored in a first CKM service 100 of a first domain 110 different from a second domain 110′ to which the user machine 210 is currently connected. The second domain 110′ may include a second CKM service 100′ that is compatible with the first CKM service 100 of the first domain 100.

FIG. 4B is a flowchart illustrating a method 460 according to one embodiment of the present invention by which a CKM service requests an encryption key from a CKM service of a different domain. When the user machine 200 is connected to the second domain 110′, it may request an encryption key from the second CKM service 100′. The request may include a domain identifier which identifies the request as being associated with the first domain 100.

In one embodiment, when the second CKM service 100′ receives 462 the request from the requestor, it detects whether or not the domain identifier of the request matches the current domain. If so, then the request is processed in a manner substantially similar to that described above with respect to FIG. 2D (and as shown in blocks 254′, 256′, 258′, and 260′ of FIG. 4B). If the domain identifier does not match the domain of the second CKM service 100′, then the second CKM service 100′ forwards the request to the domain associated with the request (e.g., the first domain 110) 468. In some embodiments of the present invention, the second CKM service 100′ first verifies that a security policies allow communication between the first domain 110 and the second domain 110′.

The second CKM service 100′ receives a response from the CKM service of the domain associated with the request (e.g., the first CKM service 100 of the first domain 110) 470. This response may be denial of the request due to a failure of authorization or the response may include the requested encryption key. The response is then returned to the requestor.

FIG. 4C is a flowchart illustrating a method by which a first CKM service 100 processes requests from another CKM service (e.g., the second CKM service 100′) according to one embodiment of the present invention. When the first CKM service 100 receives 482 the request forwarded by the second CKM service 100′, it verifies 484 that the second CKM service 100′ is authorized to access the encryption keys of the first CKM service 100. If the authorization fails, then the first CKM service 100 denies access (e.g., sends a “request denied” response) 486. If the authorization succeeds, the first CKM service 100 processes the request in a manner substantially similar to that described above with respect to retrieving keys for user machines 200 connected to same domain as the CKM service 100. For example, the first CKM service 100 may locate 488 the corresponding encryption key and then return 490 the located encryption key to the requestor via the second CKM service 100′. The first CKM service 100 may encrypt the encryption key for transfer to the second CKM service 100′ using, for example, public key encryption (e.g., with a standard PKI infrastructure) or a connection secured by transport layer security (TLS).

As such, encryption keys stored in other domains can be provided via multiple, interconnected CKM services such that secured objects (e.g., documents and user machines 200 such as laptops) can be accessed while those objects are connected to other, authorized domains.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

For example, embodiments of the present invention may be used to inspect encrypted data in transit for HIPAA compliance. In such embodiments, content inspection engines may be used to audit data flowing across boundaries to detect and prevent leakage of protected information such as personally identifiable patient records because the content inspection engines can request the decryption keys from the cloud key management service.

As another example, cloud key management systems according to embodiments of the present invention can be used to control access to data on mobile devices such as smartphones and tablets. Data secured by a cloud key management system can still be accessed from mobile devices in accordance with rules specified by the organization (e.g., whether the device is approved for use with the organization and whether the device is directly connected to the organization's internal network).

In addition, embodiments of the present invention may be used to facilitate long term archival protection with stronger cryptography, shared key schemes, and archival metadata storage formats.

What is claimed is:

1. A system for managing encryption keys within a domain, the system comprising:
a client computer coupled to a cloud key management server over a network, the client computer being configured to supply a request for an encryption key, the request comprising an object identifier associated with the encryption key; and
a cloud key management service comprising the cloud key management server, the cloud key management service being configured to:
store a plurality of encryption keys in association with a plurality of object identifiers;
receive the request from the client computer;
identify an encryption key of the stored encryption keys associated with the object identifier of the request; and
send the identified encryption key to the client computer in response to the request.

2. The system of claim 1, wherein the object identifier is associated with an encrypted file, an encrypted email, encrypted network traffic, an encrypted removable medium, or an encrypted fixed medium.

3. The system of claim 1, wherein the cloud key management server is further configured to determine whether the client is authorized to access the requested encryption key.

4. The system of claim 3, wherein the cloud key management server is further configured to deny access to the requested encryption key if the client is not within the domain.

5. The system of claim 3, wherein the request further comprises user credentials, and
wherein the cloud key management server is further configured to deny access to the requested encryption key if the user credentials are not authorized to access the requested encryption key.

6. The system of claim 5, wherein the request further comprises information regarding device identity, device credentials, device capabilities, and physical location of the device.

7. The system of claim 1, wherein the cloud key management server is further configured to receive the request via another cloud key management server within another domain, the client being coupled to the another domain.

8. The system of claim 1, wherein the cloud key management server is further configured to store a log, the log comprising:
a timestamp associated with the request;
the object identifier; and
a client identifier associated with the client computer.

9. The system of claim 8, wherein the log further comprises a user credential associated with the request.

10. The system of claim 9, wherein the user credential is a username.

11. The system of claim 8, wherein the log further comprises metadata related to the object identifier, the metadata comprising at least one element selected from the group consisting of a file type, a file size, a description, a source, an access control list, and any context supplied or derived at the time of the request.

12. The system of claim 1, wherein the cloud key management service is further configured to generate the encryption key.

13. A method of managing and supplying encryption keys within a domain, the method comprising:
storing a plurality of encryption keys in association with a plurality of object identifiers;
receiving a request from a client computer for an encryption key, the request comprising an object identifier;
identifying an encryption key of the stored encryption keys associated with the object identifier of the request; and
sending the encryption key associated with the object identifier to the client computer in response to the request.

14. The method of claim 13, wherein the object identifier is associated with an encrypted file, an encrypted email, encrypted network traffic, an encrypted removable medium, or an encrypted fixed medium.

15. The method of claim 13, further comprising determining whether the client is authorized to access the requested encryption key.

16. The method of claim 15, further comprising denying access to the requested encryption key if the client computer is not within the domain.

17. The method of claim 15, wherein the request further comprises user credentials, and
wherein the method further comprises denying access to the requested encryption key if the user credentials are not authorized to access the requested encryption key.

18. The method of claim 13, further comprising receiving the request via a cloud key management server connected to another domain, the client computer being coupled to the another domain.

19. The method of claim 13, further comprising storing a log, the log comprising:
a timestamp associated with the request;
the object identifier; and
a client identifier associated with the client computer.

20. The method of claim 19, wherein the log further comprises a user credential associated with the request.

21. The method of claim 20, wherein the user credential is a username or any other identifier commonly associated with a user, for example, an email address or employee number.

22. The method of claim 13, further comprising generating the encryption key.
